(19) United States
(12) Patent Application Publication
(10) Pub. No.: US 2011/0259368 A1
(43) Pub. Date: Oct. 27, 2011

(54) DELIVERY DEVICE

(76) Inventors: Paulus Antonius Augustinus Hofte, Astene (BE); Pedro Vincent Vandecappelle, Wetteren (BE)

(21) Appl. No.: 13/091,395

(22) Filed: Apr. 21, 2011

(30) Foreign Application Priority Data
Apr. 23, 2010 (EP) 10160967.5

(51) Int. Cl. A47L 15/42; B67D 7/06

(52) U.S. Cl. 134/18; 222/129

(57) ABSTRACT

A multi-dosing detergent delivery device for use in an automatic dishwashing machine, the device comprising a housing (101, 110) for receiving therein a detergent holder (102) and a detergent holder (102) accommodating a plurality of detergent doses (104, 106) wherein the device comprises a mono-dimensional actuating means (1) for providing movement of the holder (102) relative to the housing (101, 110).

### TECHNICAL FIELD

The present invention is in the field of delivery devices. In particular, it relates to detergent delivery devices and more in particular to an auto-dosing device that is especially suitable for the delivery of automatic dishwashing detergent over a number of dishwashing operations.

### BACKGROUND

In automatic dishwashing machines the detergent is usually charged into the detergent dispenser prior to each dishwashing operation. Different detergent delivery devices for automatic or semi-automatic delivery have been provided in an attempt to simplify the automatic dishwashing task.

Extremely attractive from a user viewpoint are stand-alone devices capable of delivering a detergent composition over a number of washes, these devices simplify the dishwashing task and provide flexibility because they are not linked to the dishwashing machine.

WO 2008/053178 A1 discloses a multi-dosing detergent delivery device, comprising a housing for receiving a cartridge, the cartridge having a plurality of chambers each accommodating a detergent composition. The device further includes a directing means to direct wash liquor selectively into a chamber of the cartridge to contact the detergent composition within it, and an outlet to allow the detergent loaded wash liquor exit the device. The device also includes indexing means for causing automatic movement of the cartridge relative to the directing means during and subsequent to a wash cycle so as to cause a neighbouring chamber to be exposed prior to a next washing cycle. The device of '178 only delivers one detergent composition per wash.

The indexing means comprises a wax motor which expands a wax canister during a heating phase of a washing cycle and contracts as it cools during and subsequent to a final cooling phase of said washing cycle. The indexing means further comprises a gearing mechanism to convert linear motion of said wax motor to rotational movement of said cartridge relative to said housing. The gearing mechanism comprises first and second rotational elements capable of movement in a first rotational direction in a first plane and a linear element which is capable of linear movement in a second plane.

The device of '178 has a cylindrical shape, cylindrical housing and cylindrical cartridge. A dose for a single wash is exposed to the wash liquor in each wash and then the cartridge rotates to prepare the next dose to be delivered for the next wash. This is done in a very complex manner, the whole cartridge is lifted up and then rotated, and afterwards the cartridge returns to its initial height. The construction of the device is quite cumbersome, there is the need to find a simpler device which involves less parts, an easier mode of operation and a simpler manufacture process. The indexing means of '178 are appropriate for cylindrical delivery devices but it would not be suitable for devices having other geometry, such as planar devices. Cylindrical devices occupy useable space in the dishwasher thus there is a need for a device whose occupancy of usable space in the dishwasher is minimized.

### SUMMARY OF THE INVENTION

According to a first aspect of the invention, there is provided a multi-dosing detergent delivery device for use in an automatic dishwashing machine. The device comprises: i) a housing for receiving therein a detergent holder; and ii) a detergent holder. The detergent holder accommodates a plurality of detergent doses. Preferably the detergent holder is replaceable or refillable. Once all the detergent doses have been used the holder can be replaced by a new holder or it can be filled with new doses. Especially preferred from an easiness of use viewpoint are replaceable detergent holders.

By “multi-dosing detergent delivery device” is meant a device capable of delivering one or more detergent doses over a plurality of automatic dishwashing operations without human intervention, i.e. the user places the device in the automatic dishwashing machine and the device delivers the doses over a number of operations. Once the detergent doses are finished the detergent holder is refilled or replaced.

The device comprises a mono-dimensional actuating means for providing movement of the holder relative to the housing. By “mono-dimensional” is herein meant that the movement happens in only one plane as opposite to more than one as the case is with the device disclosed in '178. In '178 device the indexing means needs to move firstly in one plane and secondly in a second plane perpendicular to the first one to deliver a dose in each dishwashing operation. The mono-dimensional actuating means of the device of the present invention allows for devices of simpler construction than the devices of the prior art and allows for more space efficient geometries, such as planar geometry. The device of the invention is also suitable for the delivery of different doses at different points of the dishwashing operation. '178 device seems only be suitable for the delivery one dose per dishwashing operation. The next dose is only ready for delivery in the next dishwashing operation.

Preferably, the actuating means comprises a guided means and a driving means. Preferably the driving means comprises a thermally reactive element. Whilst the thermally reactive element may be any of a memory metal/memory alloy, thermal bimetal, bimetal snap element or shape memory polymer, it is most preferably a wax motor. A wax motor is a small cylinder filled with a heat sensitive wax which expands upon melting and contracts upon solidifying. This expansion of the wax can be used by the driving means to drive the guided means forward.

The thermally reactive element is preferably designed to react at temperatures between 25° C. and 55° C., more preferably 35° C. to 45° C. The thermally reactive element preferably has a hysteresis effect. This delays the operation of the thermal element to ensure that the device is not reset by the fluctuating temperatures that can be found in the different cycles of an automatic dishwashing operation but is only reset once the machine has carried out a full dishwashing operation.

Preferably the thermally reactive element has an activation temperature of from about 35° C. to about 45° C. and a de-activation temperature of from about 25° C. to about 33° C. For the wax motor the melting and solidification profile of the wax can be used to achieve the desired hysteresis, because certain waxes show a slow solidification compared to melting.

The guided means are driven by the driving means. The guided means preferably comprise a following means and a track to accommodate the following means, i.e. the path taken by the following means is dictated by the track. The track preferably has a zig-zag configuration in which each up and down path corresponds with a full dishwashing operation. To deliver x detergent doses over x dishwashing operations the zig-zag track needs to have x paths forwards and x paths downwards.

The zig-zag track preferably can be used in a circular pattern which leads to a circular movement of the detergent holder or it can be used in a linear pattern which leads to a linear movement of the detergent holder. A wave pattern or combinations of arc segments and linear patterns can be used to accommodate specific designs and movements of the detergent holder.

It should be noted that the track can be integrated in one of the permanent component of the housing and the motion of this component can then be transferred to the detergent holder via mechanical means or the track can be integrated directly into the detergent holder so that after insertion of the holder the following means engage with the track. The track can be manufactured via injection molding, thermoforming, vacuum casting, etching, galvanizing sintering, laser cutting or other techniques known in the art.

The following means travels alternatively forwards and backwards within the track, powered by the driving means. Preferably, the actuating means further comprises returning means that helps the driving means to return to its initial position once the appropriated conditions are achieved in the automatic dishwashing machine (for example, when the temperature is below about 30° C. in the case of the driving means comprising a wax motor, the wax would contract and the returning means would take the driving means to its initial position). The returning means could for example be a biasing spring or flexible element with sufficient spring force to push the piston in the wax motor back to its initial position when the wax solidifies and therefore contracts.

The advancement of the detergent holder is accomplished by the combination of the driving means, the guided means and if present the returning means. This combination allows for the delivery of two different doses at two different times of the dishwashing operation.

For instance the first dose in the detergent holder can be readily exposed at the start of the wash cycle or get exposed to the wash water or it can be ejected from the detergent holder early in the wash cycle when the temperature slowly rises in the dishwasher and the wax motor starts to expand. The second dose can be exposed or ejected when the wax motor is further expanded when the dishwasher heats up further or during the cold rinse cycles when the first contraction starts. At the end of the wash cycle the complete contraction moves the detergent holder to the next dose ready for the next wash cycle.

It should be noted that the configuration of the track and the angles of its zig-zag pattern determine the movement of the detergent holder and therefore the movement and desired release points of detergent doses can be pre-dictated by this track. This enables large design flexibility in the delivery of the detergent doses at various times during a dishwashing operation. Even a sequential release of three or more doses can be achieved by the use of this kind of tracks.

Preferably, the track comprises slots and ramps. The role of the ramps is to guide the movement of the detergent holder in one direction only. When the temperature increases the following means are driven through the track powered by the driving means and move over the ramp into the first slot. These slots prevent that the following means return through the same path in the track upon contraction of the driving means. As such the followings means are forced to follow the desired return path in the track and translate this movement into a further movement of the detergent holder. At the end of the contraction the following means are driven over a second ramp into the next slot and move the detergent holder further.

To enable the following means to move up over the ramps and down into the slots the following means can be designed to pivot either by a spring loaded pin or by a pivot point to keep the following means at all times in the track.

Preferably, the track comprises harbours. The role of the harbours is to allow further expansion or contraction of the driving means without causing further movement of the detergent holder and to prevent the build-up of high forces in the system when the driving means reaches its maximum expansion or contraction. For instance with a wax motor with a total expansion stroke of 15 mm, the harbours enable to use only the expansion from 5 mm to 10 mm to generate movement of the detergent holder while in the first 5 mm or last 5 mm of the stroke the following means are kept in the harbours and therefore the detergent holder is kept in the same position. This feature helps to overcome the large variation in dishwashing machine cycles and temperature profiles and enable a very specific and pre-defined movement of the detergent holder.

The device is preferably a stand-alone device. By “stand-alone” is herein meant that the device is not connected to an external energy source.

The device of the present invention is preferably of a planar geometry (ie., a disc, a square, a rectangle, etc). Planar geometry is more space efficient than any tri-dimensional geometry, thereby leaving more free space in the dishwasher for the items to be washed.

Preferably, the multi-dosing delivery device of the invention delivers at least two different doses during each dishwashing operation, each of the doses being different from each other in terms of composition. A first dose is delivered at the beginning of a dishwashing operation, preferably at the beginning of the main-wash cycle, at this point the dishwasher is cold. The temperature of the wash increases and preferably when it reaches approximately between 30° and 45°, more preferably between 35° and 39° C. a second dose is delivered. At the end of the dishwashing operation the dishwasher cools down and the driving means helped by the returning means go back to their initial position to drive the following means to have a new composition ready for the delivery in the next dishwashing operation.

Preferably, the at least two different doses are delivered sequentially. By “sequentially” it is meant that the doses are delivered at different times. Preferably the doses are delivered at least 1 minute, more preferably at least 2 minutes and especially at least 3 minutes from one another.

According to the last aspect of the invention there is provided a method of automatic dishwashing comprising the step of sequentially delivering at least two different doses using the device of the invention.

Preferably the device includes an indication mechanism to show how many doses are used up or still remain so that the user has an idea of when replacement of the detergent holder is required. The simplest way to achieve this is by indicating a series of numerals or other icons on the detergent holder which correspond with the position of the dosing chambers and combine this with a window on the outer housing in order to enable the consumer to view the specific indication without the need to remove the device from the machine. Other marking mechanism or mechanical transferring systems to indicate the position or fill level can be used. With more advanced mechanical systems even sounds or light signals can be generated using the motion of the driving and guiding means as the energy source to build-up and trigger the signal for instance by winding up and storing energy in a coil spring which is released two or three dosages before the entire detergent holder is empty.

### BRIEF DESCRIPTION OF THE DRAWINGS

FIG. 1 shows in perspective an assembly view of the actuating means 1 comprising a baseplate with the driving means 2 and a rotating cover with the guided means 5.

FIG. 2 shows a perspective assembly detail of the driving means 2 with the rotating cover 5 removed.

FIG. 3: shows a perspective view of the circular guided means inside the rotating cover 5 with a circular zig-zag track 10.

FIGS. 4(a) and 4(b) are perspective exploded views of the actuating means mechanism with following means 8 with follower pin 9 and returning means 7 and 71.

FIG. 5 shows in perspective cross-sectional view the assembled actuating mechanism with wax motor 18 and follower pin 9 in the expanded position.

FIGS. 6(a) and 6(b) shows respectively a schematic perspective of the actuating mechanism in a cylindrical housing and in a planar disc shaped housing.

FIG. 7 shows an exploded view of the multi-dosing detergent holder 102 in a disc shaped housing 101 and 110 with the actuating mechanism.

FIG. 8 shows a perspective assembly view of the actuating mechanism 51 for a rectangular shaped guided means.

FIG. 9 shows a perspective view of the rectangular guided means 55 with a linear zig-zag track 100.

FIGS. 10(a) and 10(b) show perspective assembly views of the actuating mechanism 51 and the rectangular guided means 55.

FIG. 11 shows a schematic view of the rectangular shaped multi-dosing detergent holder 55 comprising the guided means with linear track 100 comprising multiple doses of the first detergent composition 104 and the second detergent composition 106.

FIG. 12 shows a perspective detailed schematic view of the driving means 18 driving the following means 8 with follower pin 9 through the linear track 100 of FIG. 11.

FIG. 13 (a) and FIG. 13 (b) respectively show a schematic view of the driving means in contracted (cold) position (i.e.; temperature less than 30-34° C. wax contracts return stroke via bias spring) and in the expanded (hot) position (i.e.; temperature greater than 36-38° C. wax expands stroke up to 15 mm).

FIG. 14 shows a graph illustrating the hysteresis profile of the actuation temperature of the wax motor during an expansion (heating) and contraction (cooling) cycle.

### DETAILED DESCRIPTION OF THE INVENTION

An automatic dishwashing operation typically comprises three or more cycles: a pre-wash cycle, a main-wash cycle and one or more rinse cycles. The pre-wash is usually a cold water cycle, the main-wash is usually a hot water cycle, the water comes in cold and is heated up to about 55 or 65° C. Rinsing usually comprises two or more separate cycles following the main wash, the first being cold and, the final one starting cold with heat-up to about 65° C. or 70° C.

Examples of devices in accordance with the present invention will now be described with reference to the accompanying drawings, in which:

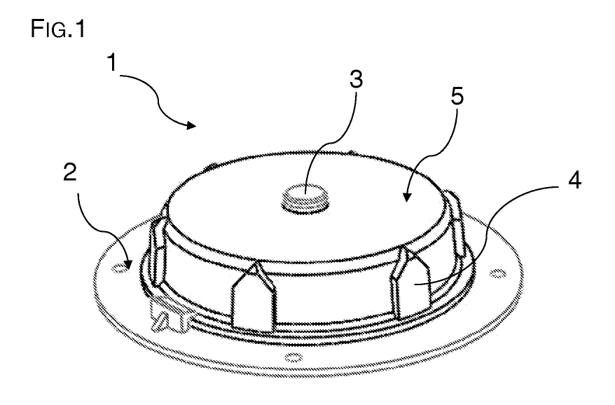

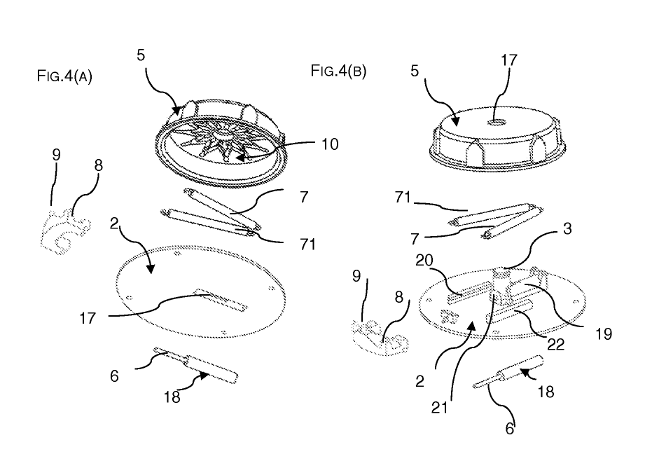

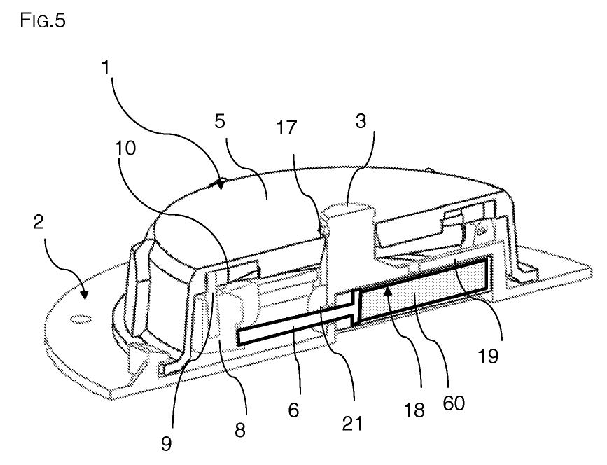

FIGS. 1, 2, 3, 4 and 5 show respective assembled, perspective exploded and internal perspective views of the rotating actuating means 1 comprising the driving means 2 and the guided means 5. The driving means 2 comprises an axis 3 around which the cover with the guided means 5 can rotate at specific intervals defined by the profile of the guided track 10 inside the cover 5.

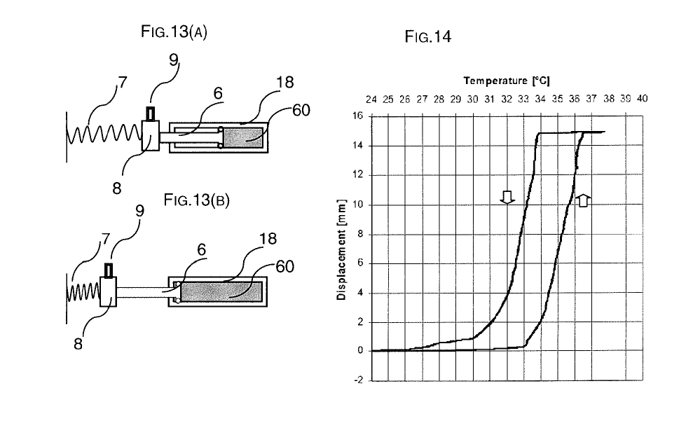

The driving means further comprise a thermal reactive element 18 which is in this configuration a wax motor. As shown in FIG. 13(a) a wax motor 18 is basically a cylinder filled with a thermal sensitive wax 60 under a piston 6. When temperature in the automatic dishwashing machine brings the wax to or above its melting temperature it will start to expand as shown in FIG. 13(b) This expansion pushes the piston outwards developing a considerable force, up to 50N and more and a considerable movement, or stroke of the piston. For instance for a cylinder with a total length of 30 mm and +/−6 mm diameter half filled with a solid wax under the piston a stroke of the piston of 15 mm can be achieved, meaning an expansion of the wax by a factor 2 upon melting.

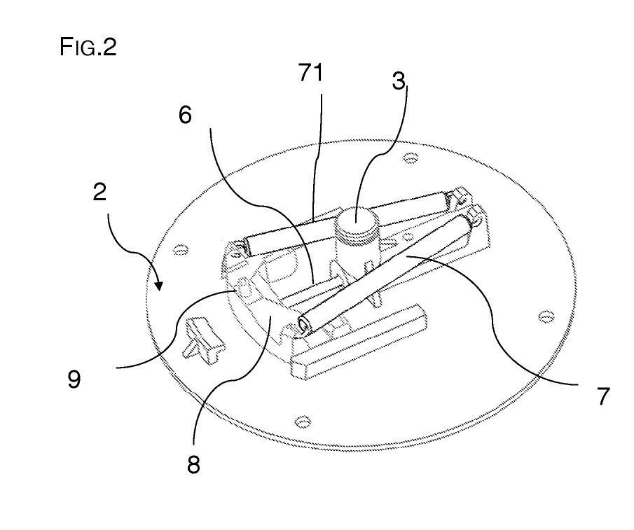

This outward movement of the piston puts the returning means, which in FIG. 2 are two coil springs 7 and 71, and in FIGS. 13(a) and 13(b) a single coils spring, under tension.

When the temperature in the dishwasher cools down below the solidification temperature again, at the end of the wash, the wax contracts, allowing the piston 6 to move back. The returning means pushes the piston back into the starting position.

This forwards and backwards movement of the piston or “the stroke” of the wax motor 18 is used to drive the following means 8 with the following pin 9 forward and backwards assisted by the returning means 7 and 71. The returning means, in this case two tension springs 7 and 71 are connected on one side to the following means 8 and on the other side to the static baseplate 2. To achieve a linear and smooth motion forward and backwards the following means run in supporting rails 20 and 22.

It should be noted that the returning means in the form of a compression spring can also be inserted inside of the wax motor 18, above the piston 6 so that upon expansion of the wax the spring compresses and upon cooling it can expand to its starting position.

In one preferred embodiment of the invention this forward and backwards movement of the driving means 18 and following means 8 and following pin 9 can now be used to rotate the cover 5 via the guided means 10 on the inside of this cover.

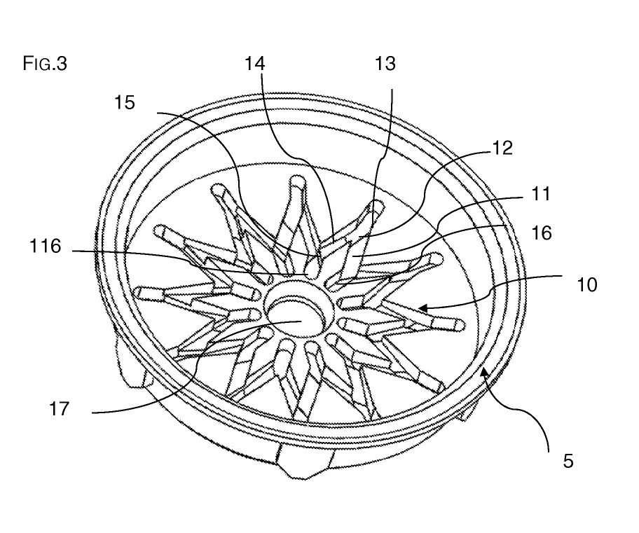

FIG. 3 shows a detail of the guided means, in this configuration the guided means 10 are a circular zig-zag repetitive track with harbours 13 and 16, ramps 11 and 14 and slots 12 and 15. The following describes one complete cycle:

At the start of an automatic dishwashing operation the automatic dishwashing machine is cold and the wax motor is contracted with the follower pin 9 positioned in the “cold” harbour 16. When the machine heats up the wax starts to expand when it reaches its melting temperature. This drives the follower pin 9 forward through the first path of the track over the ramp 11 and as such rotates the cover over a certain angle. At further expansion the following pin drops over the ramp into the slot 12 and from there the further expansion drives it into the “warm” harbour 13. The harbour allows the following pin to continue moving till full expansion without causing any further movement to the cover 5.

When the automatic dishwashing machine starts to cool down below the solidification temperature of the wax, the wax motor slowly starts to contract and moves the following pin out of the “warm” harbour 13. The slot 12 prevent that pin can return through the path with ramp 11 and therefore forces the pin to follow the new path over ramp 14 into slot 15 causing a further rotation to the cover 5. The further contraction moves the pin 9 back into the next “cold” harbour 116 where it can fully contract without causing further motion to the cover 5.

At this point the actuating device is ready for the next dishwashing operation.

It should be noted that one forward and backward movement through the zig-zag track corresponds with one complete wash program of the dishwashing machine.

In this circular configuration as per FIG. 3 the multiple peaks and valleys on the zig-zag track define the number of detergent dosages that can be provided. The shown configuration can automatically provide detergent over 12 complete dishwashing operations.

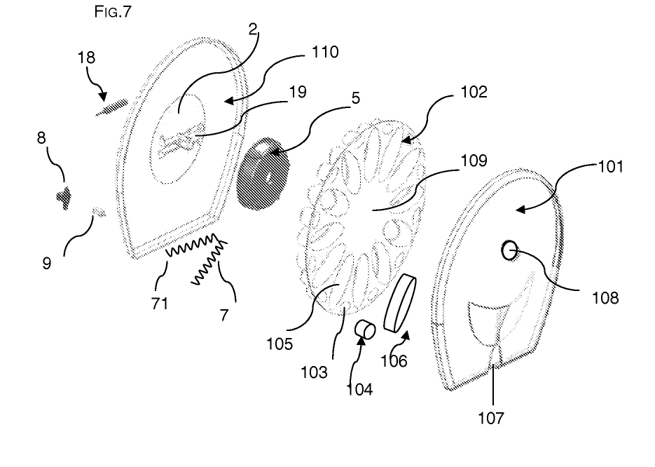

It will now be described how the rotational movement of the cover 5 drives the detergent holder 102 in the housing 110 and 101 shown in exploded perspective view FIG. 7. In this configuration the driving means 2 with the wax motor 18, the returning means 7 and 71 and following means 9 and follower pin 9 are in this case integrated in one half of the housing 110. The rotating cover 5 with guiding means is clipped over it with the follower pin positioned in the first “cold” harbour.

The detergent holder 102 with the multiple detergent doses is inserted in this housing with the bottom engaging with the rotating cover 5. The housing is closed with the second half of the housing 101. The cover 5 can have guiding ribs 4 and other features to easily mate with detergent holder 102 so that the circular movement of the rotating cover can be transferred to the detergent holder throughout the various dishwashing operations.

It should be noted that the configuration of the track 10 and the angles of its zig-zag pattern determine the movement of cover 5 and thus the detergent holder 102. Therefore the movement and desired release points can be dictated by this track. This enables large design flexibility in the delivery of the products at various points during the wash and rinse cycle(s). Even a sequential release of two or more doses can be achieved by the use of this kind of tracks.

In another preferred embodiment the guided means 10 can be directly integrated into the detergent holder 102. In this case there is no need for a rotating cap 5 and the back and forward motion of the driving means can be directly transferred into the rotation of the detergent holder.

It should be noted that in this case the pattern of the track can be flexible and be different for different detergent holders, enabling specific release points in the dishwashing operation tailored to deliver different detergent doses at optimum times in a dishwashing operation.

The zig-zag track 10 in the rotating cap or into the detergent holder can be formed via various techniques known in the art like injection molding, thermoforming, compression molding, laser cutting, etching, galvanising or the like or can be separately produced and fixed to cap or the detergent holder via well known glueing, welding or sealing or mechanical clipping techniques.

The release of the detergent doses can be established in various ways using this multi-dosing detergent delivery device. In one preferred embodiment shown on FIG. 7 a first detergent dose 104 and a second detergent dose 106 are placed in separate cavities 103 and 105 of the detergent holder 102. The detergent holder in this case can contain a non limiting number of 12 doses of the first and 12 doses of the second detergent.

At the start of the dishwashing operation the first detergent 104 can be exposed to the wash liquor in the automatic dishwasher via the open gate 107 in the housing while the other detergent doses are protected from the liquor by the housing. As explained before as the temperature rises the wax in the wax motor 18 expands and the piston 6 drives the follower pin 9 through the track 10 which rotates the detergent holder 102 to the next position where the second detergent 106 gets exposed to wash liquor via the open gate 107. When the machine cools down again the wax motor contracts and rotates the detergent holder to the next position ready for the next wash.

It should be noted that during the rotation more than one detergent dose can be exposed or released sequentially, either direct at the start, in the first prewash, during the main-wash or during the first or second rinse cycle and even during the final heating, drying cycle and cooling cycle by accurately making use of the specific expanding or contracting stroke length of the wax motor in function of temperature. The shape and angles of the zig-zag track then define the rotational speed and rotational angle of the detergent holder.

The first 104 and or second detergent doses 106 can either be exposed to the wash liquor or can be dropped into the dishwashing machine through the open gate 107 using gravity or by actively pushing it out of the cavities 103 and/or 105 by running the detergent holder over a small ramp featured on the inside of the housing 110. This ramp feature applies a gradual increasing force on the underside of the cavity to pop the detergent dose out of the cavities 103 and/or 105 during the rotational movement. In this case a deformable base in the detergent holder like a flexible deep drawn film, a blister pack or thin wall thermoformed cavities will help the release of the first and/or second detergent doses.

In another embodiment the ramp feature can run through one or more open slots in the base of the detergent cavities 103 and/or 105 to actively push the content out through the open gate 107 into the dishwashing machine. In a further variation the housing can have more than one open gate 107.

The first and second detergent doses can be protected against the high humidity and high temperature conditions in the dishwashing machine via additional sealing and barrier features and materials in the housing or by covering the cavities of the detergent holder with a water-soluble PVA film or a non soluble moisture barrier film which can be pierced or torn open during the release operation.

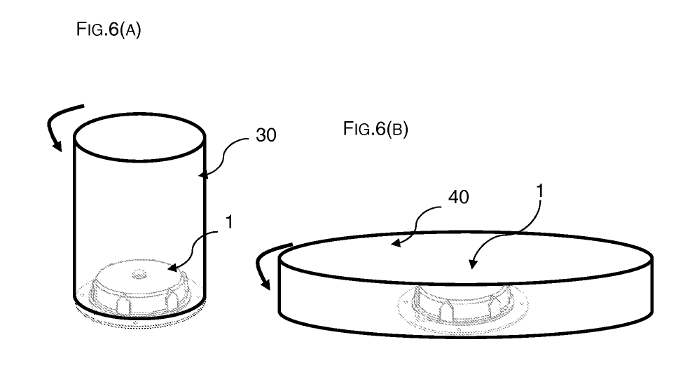

The perspective view in FIGS. 6(a) and 6(b) illustrate that the actuating means 1 can be used in a cylindrical housing 30 or in a disc shaped housing 40 or any further shape that can accommodate the rotational movement. The detergent holders can also have different shapes to match with these specific housings.

Further means for easy insertion and removal of the detergent holder can be integrated in the housing and the detergent holder, like locking features, clipping features, (spring loaded) opening features, (spring loaded) ejecting features, etc.

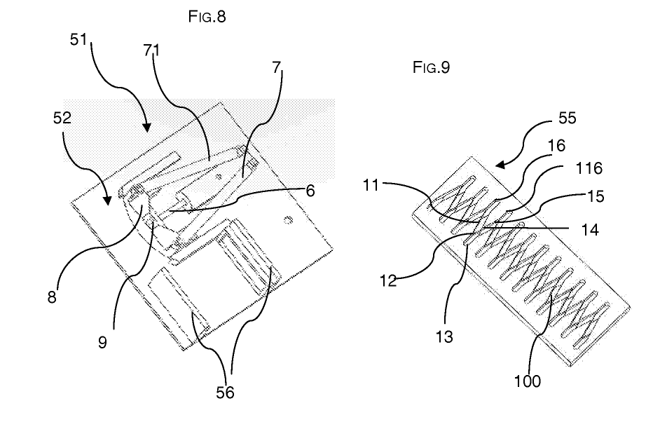

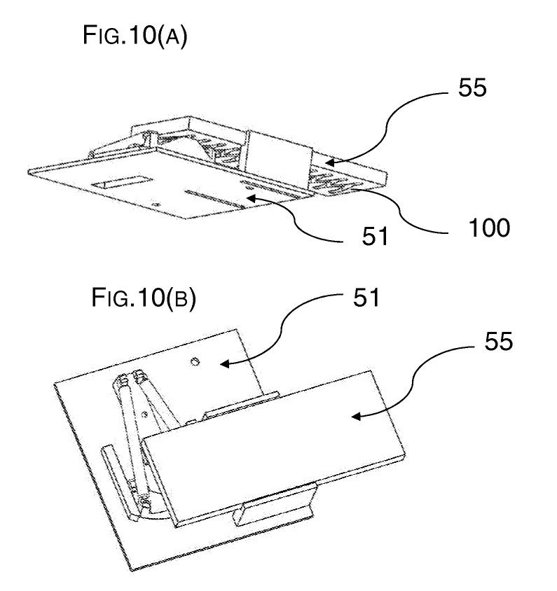

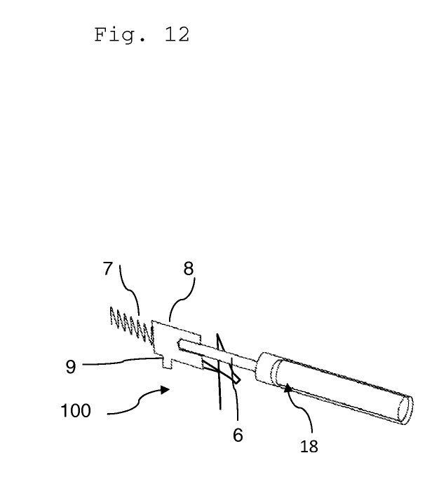

Another embodiment of this invention is shown in the perspective assembly, detailed and exploded views shown in FIGS. 8, 9, 10, 11 and 12. The driving means with the wax motor 18 and the forward and backward moving following means 8 and follower pin 9 on the piston 6 are in this configuration transferred into a linear unidirectional motion of the guided plate 55 via the linear zig-zag track 100 with ramps, slots and harbours as described before.

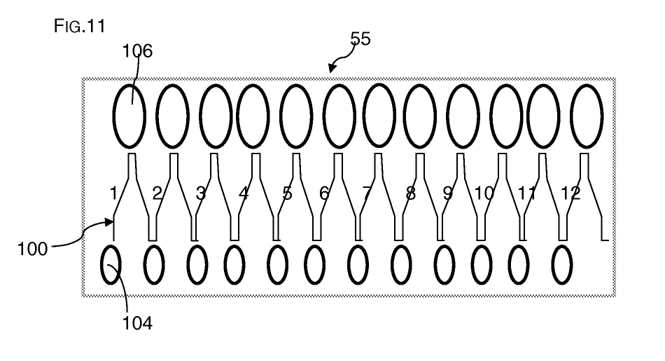

As shown in FIG. 11 this linear zig-zag track 100 can be integrated into a rectangular shaped detergent holder 55 with a number of individual cavities containing the first 104 and second detergent doses 106. As described before each up and down path through the track 100 corresponds with a heating and cooling phase during the dishwashing operation. Two or more detergent doses can be delivered one after the other in the dishwashing machine at specific points in the wash. On FIG. 11 detergent doses for twelve different dishwashing operations are shown however it should be understood that this can easily be varied from 2 to 36 or more dishwashing operations, depending on the size of the detergent holder.

In a preferred embodiment of the invention this rectangular shaped detergent holder is a blister pack.

The automatic dishwashing detergent delivery system of the invention can have further features to indicate the number of doses used or still left to help the consumer decide when to refill the detergent holder. FIG. 7 shows a transparent window 108 on the housing 101 to display one number of a range, printed or marked in a circular pattern on the centre 109 of the detergent holder 102. When the detergent holder rotates, from one dishwashing operation to the next, the number changes behind the window 108. It should be noted that other characters, specific icons or colour coding can be used to communicate how many doses are left.

In more advanced executions of the invention sound or light signals can be generated by for instance storing energy in a coil-spring that slowly winds up with the rotational movement of the detergent holder and releases it energy via a mechanical switch when the detergent holder is almost empty.

In preferred embodiments of the invention a machine fresher composition can be accommodated in each detergent holder, for instance by placing it in a central cavity of the detergent holder to continuously release a perfume or bad odour suppressor into the dishwashing machine over the number of dishwashing operations and in between dishwashing operations. This machine fresher composition can be activated at first use by removing a sealing label or the like covering the cavity.

### Automatic Dishwashing Composition

Automatic dishwashing compositions for use in the device of the invention can comprise a phosphate builder or a non-phosphate builder and one or more detergent active components which may be selected from surfactants, enzymes, bleach, bleach activator, bleach catalyst, polymers, dying aids and metal care agents. In cases in which more than one dose is delivered into one dishwashing operation, the first dose preferably comprises a bleach and the second dose enzymes, preferably the first dose compose a chlorine bleach and the second dose enzymes and a bleach scavenger. The separation of bleach and enzymes during storage improve the stability of the product. The sequential delivery of doses improve cleaning.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A multi-dosing detergent delivery device for use in an automatic dishwashing machine, the device comprising a housing for receiving therein a detergent holder and a detergent holder accommodating a plurality of detergent doses wherein the device comprises a mono-dimensional actuating means for providing movement of the holder relative to the housing.

2. The device according to claim 1 wherein the mono-dimensional actuating means comprises a guided means and a driving means.

3. The device according to claim 1 wherein the guided means are associated to the driving means to drive the guided means in opposite directions.

4. The device according to claim 1 wherein the mono-dimensional actuating means further comprises a returning means for the driving means.

5. The device according to claim 1 wherein the guided means comprises a following means and a track to accommodate the following means.

6. The device according to claim 1 wherein the track comprises slots and ramps.

7. The device according to claim 1 wherein the track has a zigzag configuration.

8. The device according to claim 5 wherein the track comprises harbours.

9. The device according to claim 1 wherein the device is a stand alone device and the actuating means are mechanically activated.

10. The device according to claim 1 wherein the actuating means are mechanically activated by an activator triggered by the change of physical conditions in the dishwasher.

11. The device according to claim 1 wherein the device is planar.

12. The device according to claim 1 wherein the device is suitable for the sequential delivery of at least two different detergent doses during the dishwashing process.

13. A method of automatic dishwashing comprising the step of sequentially delivering at least two different doses using the device according to claim 1.
